(19) United States
(12) Patent Application Publication
(10) Pub. No.: US 2005/0213115 A1
(43) Pub. Date: Sep. 29, 2005

(54) Print job system and method

(76) Inventors: Bruce Johnson, Eagle, ID (US); Tom Skeie, Boise, ID (US); Charles Eric Cantwell, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/900,822

(22) Filed: Jul. 28, 2004

Related U.S. Application Data
(60) Provisional application No. 60/557,363, filed on Mar. 29, 2004.

(51) Int. Cl. G06F 15/00

(52) U.S. Cl. 358/1.1; 358/1.16

(57) ABSTRACT

The present inventive subject matter provides various embodiments of systems and methods useful in print job accounting. Some such embodiments include adding a first queue to a print path, routing a print job to the first queue, and attaching a print job identifier to the print job.

### RELATED APPLICATIONS

This application claims the benefit under 35 U.S.C. 119(e) of U.S. Provisional Application Ser. No. 60/557,363 filed Mar. 29, 2004.

### BACKGROUND

Print job accounting is becoming more and more important in many computing environments. Print job accounting deals with tracking and recording properties of print jobs for various purposes such as ensuring print jobs complete successfully, internal cost accounting, client or user billing, tracking print activity by certain individuals or departments, or for other similar purposes. These purposes of print job accounting require accuracy and reliability in the accounting data.

Some present solutions for print job accounting track printing from the Windows spooler. However, this is not necessarily an accurate accounting of print activity. These solutions do not allow for post print job querying of printers to ensure the print job was successful. Some other present solutions do provide post print job querying. However, these solutions accomplish this by modifying spooler files of print jobs while in the spool file directory. This requires continuous monitoring and pausing/restarting of print queues and results in additional overhead, decreased reliability, and slower processing and printing. These present systems fail to provide accurate and reliable print job accounting.

### BRIEF DESCRIPTION OF THE DRAWINGS

FIG. 1 provides a block diagram of a system, according to an embodiment of the present inventive subject matter.

FIG. 2 provides a block diagram of one example system, according to an embodiment of the present inventive subject matter.

FIG. 3 provides a schematic diagram of a system, according to an embodiment of the present inventive subject matter.

FIG. 4 provides a block diagram of a system, according to an embodiment of the present inventive subject matter.

FIG. 5 is a flow diagram of a method, according to an embodiment of the present inventive subject matter.

FIG. 6 is a flow diagram of a method, according to an embodiment of the present inventive subject matter.

FIG. 7 is a flow diagram of a method, according to an embodiment of the present inventive subject matter.

FIG. 8 is a flow diagram of a method, according to an embodiment of the present inventive subject matter.

FIG. 9 is a flow diagram of a method, according to an embodiment of the present inventive subject matter.

FIG. 10 is a schematic diagram of a computer readable medium, according to an embodiment of the present inventive subject matter.

FIG. 11 is an exemplary data structure, according to an embodiment of the present inventive subject matter.

### DETAILED DESCRIPTION

In the following description and the drawings illustrate exemplary embodiments of the inventive subject matter sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the inventive subject matter encompasses the full ambit of the claims and all available equivalents. The following description is, therefore, not to be taken in a limited sense, and the scope of the present inventive subject matter is defined by the appended claims.

System Overview. FIG. 1 shows a system 100, according to one embodiment of present inventive subject matter. The system 100 includes a network 106 operatively coupling a client 102, a server 104, and a printer 108.

One embodiment of the system 100 is a system of modified print queues to allow monitoring and modification of print jobs flowing through a print path, while leaving any existing drivers or other print components undisturbed. One such embodiment of a system 100 includes a virtual print queue for adding print job identification information to print jobs prior to sending the print jobs to an original print queue. When the virtual print queue sends a print job onto the original print queue, the virtual print queue opens a thread with the printer for tracking the print job, and makes an entry in a storage location including information about the print job. In some embodiments, the virtual print queue is on the client 102. While, in other embodiments, the virtual print queue in on the server 104.

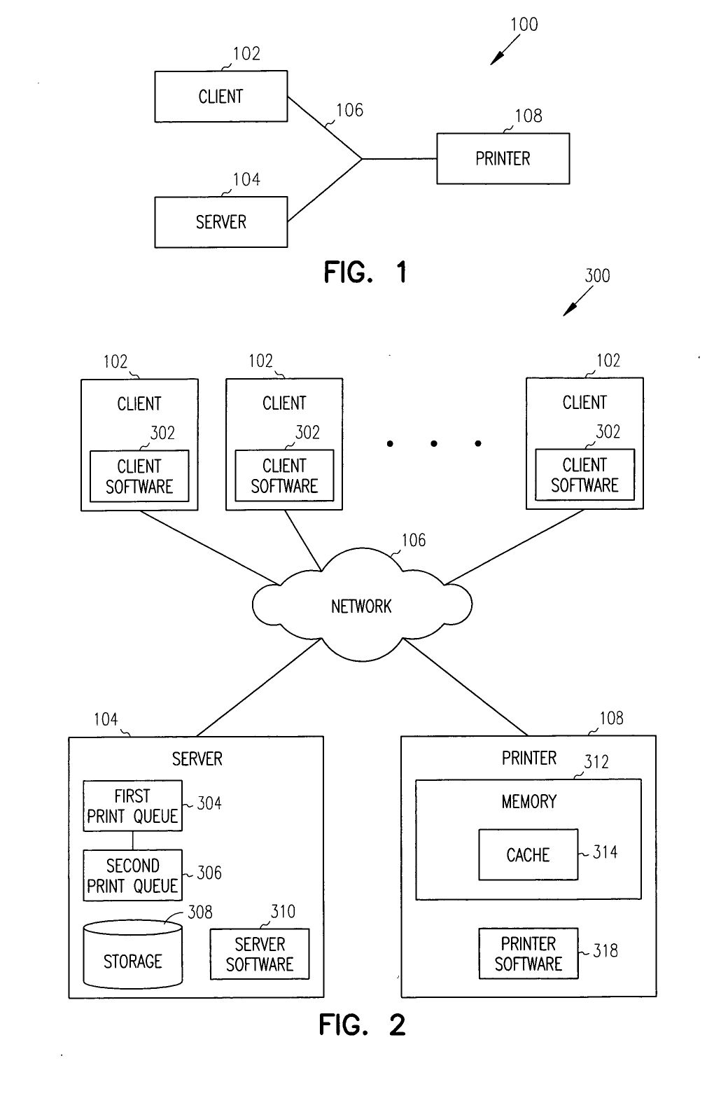

Hardware and Operating Environment. FIG. 2 shows a system 300, according to one embodiment of the present inventive subject matter. The system 300 includes a network 106 operatively coupling one or more clients 102, a server 104, and a printer 108.

In some embodiments of the system 300, the network 106 is a local area network (LAN). In other embodiments, the network 106 is a wide area network (WAN). In yet further embodiments, the network 106 includes virtual private networks (VPN), the Internet, and various hybrids of network types including interconnections between the various types of networks. The network 106 can be virtually any type or arrangement of networks.

In some embodiments, the clients 102 are personal computers (PC) with computer programs thereon that include the ability to print documents. In other embodiments, the client is a computing device 202, as shown in FIG. 2 and described in detail below, with computer programs thereon that include the ability to print documents. In some such embodiments, the ability to print documents includes spooling documents to a first print queue on a print server.

In some embodiments, the server 104 is a Microsoft Windows-based server. In other embodiments, the server 104 is a computing device 202, as shown in FIG. 2 and described in greater detail below.

In some embodiments, the printer 108 is a networked printer. In some such embodiments, the printer 108 includes a network interface card (NIC) for communicating over the network 106. In various other embodiments, the printer 108 is a laser printer, an inkjet printer, an impact printer, or other similar type printer for causing an electronic signal to be transformed into an image on a sheet of paper, transparency, or other types of media. Some such images include text.

Some embodiments of the system 300 further include on the server 104, a first print queue 304, a second print queue 306, and a storage 308. In some such embodiments, the server 104 includes software 310 operable on the server 104 to receive print job files from a client 102 into the first print queue. The server 104 then modifies the print job in the first print queue 304 to insert information to facilitate print job accounting. The server 104 then forwards the print job to the second print queue 306 which sends the print job to the printer 108. When the print job is sent from the first print queue 304 to the second print queue 306, the first print queue 304 communicates with the printer 108 over the network 106 to track the progress of the print job based on the information inserted into the print job while in the first print queue 304. Once the print job has been completed, either successfully or unsuccessfully, the first print queue 304 receives notice from the printer 108 and closes the communication with the printer 108. The first print queue 304 then makes an entry in a print job accounting data repository. In some embodiments, the print job accounting data repository is located in the storage 308 of the server 104 or in another networked storage location. In some such embodiments, the storage is a database such as a relational database that allows for querying using a query language such as structured query language (SQL) for reporting and mining information from the database.

Another embodiment of the system 300 includes software operable on various components of the system 300. In various embodiments, this software includes client software 302, server software 310, and printer software 318. The client software 302 is operable on the clients 102 to cause a print job to be spooled from the client to a first print queue 304 on the server 104. The server software 310 then attaches information to the print job while in the first print queue 304 and forwards the print job to a second print queue 306. The server software 310 further causes the server 104 to send the print job on to the printer 108. The printer software 318 extracts information from received print jobs and stores the extracted information in a cache 314 located in a memory 312 of the printer 108. The extracted information includes properties about the print job and information attached to the print job while the print job was in the first queue.

In some such embodiments of the system 300, the first print queue 304 is a virtual print queue and second print queue 306 is an actual print queue that forwards print jobs onto the printer. The virtual print queue is inserted between the actual print queue and the client 102 generating a print job. In some such embodiments, the virtual print queue is visible on the clients 102 as if it were an actual print queue. In some of these embodiments, the actual print queue is invisible to the clients 102. This forces all print jobs to flow through the virtual print queue such as the first print queue 304 on the server 104.

The information attached to a print job while in the first print queue 304 varies depending on several factors including the requirements of the specific embodiment. In some embodiments, attaching information to print jobs in the first print queue 304 on the server 104 includes inserting one or more tags to the print job file. In some embodiments, these tags are print job identifiers that allow for unique tracking of print jobs. The print job identifier, in some embodiments is a universally unique identifier (UUID) such as a globally unique identifier (GUID). A GUID is a pseudo random number used in software applications that is generally a unique number. In some embodiments, a GUID is created using various functions available as part of an operating system or computer programming language. In other embodiments, the GUID is created by the server software 310 by obtaining a number associated with the server 104 such as a MAC address, IP address, or other machine specific identification number and attaching a date-time stamp to it.

In various embodiments, the server software 310, after attaching the information to a print job in the first print queue, opens a communication thread with the printer 108. This communication thread is used by the server 104 to obtain information from the printer 108 about the success of a print job. In some such embodiments, the printer software 318 receives from the server software 310 the print job identifier attached to the print job while in the first print queue 304. When the server completes the print job, either successfully or unsuccessfully, the printer communicates an indication of success along with other information about the print job, as required by the specific embodiment. In various embodiments, the other information includes number of pages printed, time to complete print job, color or black and white printing, a printing cost calculation, type of paper used, and other information related to the properties of the print job processed by the printer 108.

In some other embodiments, the server software 310 does not cause the server 104 to open a communication thread with the printer 108. In such embodiments, the printer software 318 is more robust. This printer software 318, causes the print job information to be stored into a data repository such as a storage device 308 on the server. In some embodiments, the printer software 318 causes the printer 108 to make an entry into the data repository upon completion of a print job. In other embodiments, the printer software 318 stores print job information in a cache 314 located in the printer memory 312. The printer software 318 then at a threshold point, causes the print job information to be stored in the data repository. The threshold point in some embodiments is a certain period of time, while in other embodiments the threshold point is a number of print jobs with information in the cache 314.

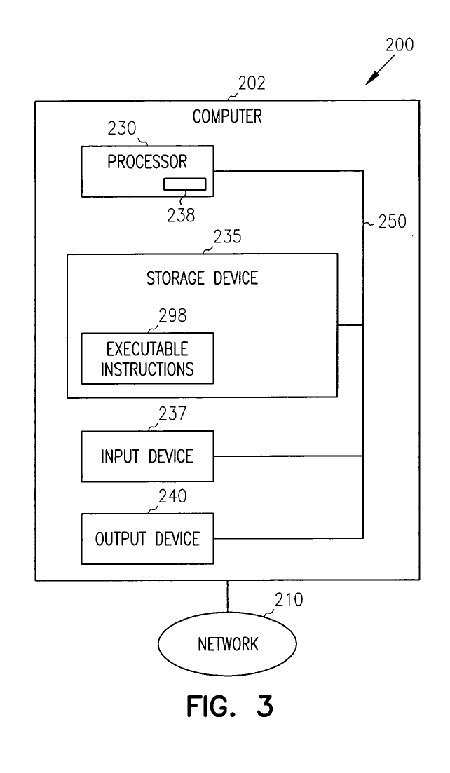

FIG. 3 is a schematic diagram of an electronic device 200. In various embodiments of the systems described above, such as system 100 of FIG. 1 and system 300 of FIG. 2, clients 102 and servers 104, as illustrated and described, can be an electronic device 200. The electronic device 200 includes a computing system 202, according to an embodiment of the present inventive subject matter. The computer system 202 includes a processor 230 and a storage device 235. The storage device 235 includes executable instructions 298. The executable instructions 298 are stored within the storage device 235. The electronic device 200 can include an interface or connection to a network 210. The network 210 can correspond to network 106 (shown in FIG. 1). The computing device 202 is communicatively coupled to the network 210.

The processor 230 represents a central processing unit of any type of architecture, such as a CISC (Complex Instruction Set Computing), RISC (Reduced Instruction Set Computing), VLIW (Very Long Instruction Word), or hybrid architecture, although any appropriate processor may be used. The processor 230 executes instructions. The processor 230 also includes a control unit 238 that organizes data and program storage in memory and transfers data and other information in and out of the computing device 202 and to and from the network 210 and other devices attached to the network 210. The processor 230 receives input data from the input device 237 and the network 210, reads and stores code and data in the storage device 235, and presents data to an output device 240 and/or the network 210.

Although the computing device 202 is shown to contain only a single processor 230 and a single bus 250, the present invention applies equally to computing devices 202 that include multiple processors and multiple buses with some or all performing different functions in different ways.

The storage device 235 represents one or more mechanisms for storing data. For example, the storage device 235 may include read only memory (ROM), random access memory (RAM), magnetic disk storage media, optical storage media, flash memory devices, and/or other machine-readable media. In other embodiments, any appropriate type of storage device may be used. Although only one storage device 235 is shown, multiple storage devices and multiple types of storage devices may be present. In various embodiments, some or all of the controller 238, or other items shown as stored with the storage device 235 may be stored on the same or on different storage devices. Furthermore, although the computing device 202 is drawn to contain the storage device 235, it may be distributed across other computing devices, such as other computing devices attached to the network 210.

The controller 238 includes instructions capable of being executed on the processor 230 to carry out the functions of the present inventive subject matter. In another embodiment, some or all of the functions of the present inventive subject are carried out via hardware in lieu of a processor-based system.

The input device 237 may be a keyboard, mouse or other pointing device, trackball, touchpad, touch screen, keypad, microphone, voice recognition device, or any other appropriate mechanism for the user to input data to the electronic device 200. Although the input device 237 is represented as one box as shown in FIG. 3, it is to be understood that in another embodiment the one box can represent a plurality of input devices.

The output device 240 is that part of the computing device 202 that communicates outputs to a device user. In some embodiments, the output device 240 can also communicate outputs to other computing devices. The output device 240 in some embodiments is a cathode-ray tube (CRT) based video display. In other embodiments the output device 240 is a liquid crystal display (LCD) based or gas, plasma-based, flat-panel display. In another embodiment, the output device 240 includes a speaker. In still other embodiments, the output device 240 includes any appropriate output device. Although one output device 240 is shown, in other embodiments, any number of output devices of different types or of the same type may be present. In one embodiment, the output device is part of the computing device 202, such as a flat panel display on an exterior housing of the computing device. In another embodiment, the output device is a separate, stand-alone device.

The bus 250 may represent one or more busses, e.g., PCI, ISA (Industry Standard Architecture), X-Bus, EISA (Extended Industry Standard Architecture), or any other appropriate bus and/or bridge (also called a bus controller).

The computing device 202 may be implemented using any suitable hardware and/or software, and includes many types of devices. For example, a computing device 202 includes personal computers, portable computers, laptop or notebook computers, PDAs (Personal Digital Assistants), pocket computers, main frame computers, telephones, pagers, printers, multi-function peripherals, digital sending devices, facsimile machines, imaging devices, appliances, and other devices. The other devices may include any device that uses firmware associated with the device. The hardware and software depicted in FIG. 3 may vary for specific applications and may include more or fewer elements than those depicted. For example, other peripheral devices such as audio or chip programming devices, such as EPROM (Erasable Programmable Read-Only Memory) programming devices may be used in addition to or in place of the hardware already depicted.

The network 210, such as network 106 (shown in FIG. 1), can be any suitable network and may support any appropriate protocol suitable for communication between the electronic device 200 and other devices attached to one another through the network. In one embodiment, the network 210, such as network 106, supports wireless communications using a technology such as IEEE (Institute of Electrical and Electronics Engineers) 802.11a/b/g or any other similar technology. In another embodiment, the network 210, such as network 106, may support hard-wired communications, such as a telephone line or cable. In another embodiment, the network 210 supports the Ethernet IEEE 802.3x specification. In another embodiment, the network 210 is the Internet and supports IP (Internet Protocol). In another embodiment, the network 210 is a local area network (LAN) or a wide area network (WAN). In another embodiment, the network 210 is the Intranet. In another embodiment, the network 210 is a GPRS (General Packet Radio Service) network. In another embodiment, the network 210 is any appropriate cellular data network or cell-based radio network technology. In still another embodiment, the network 210 is any suitable network or combination of networks. Although one network 210 is shown, in other embodiments any number of networks (of the same or different types) may be represented by the network element 210 shown in FIG. 3.

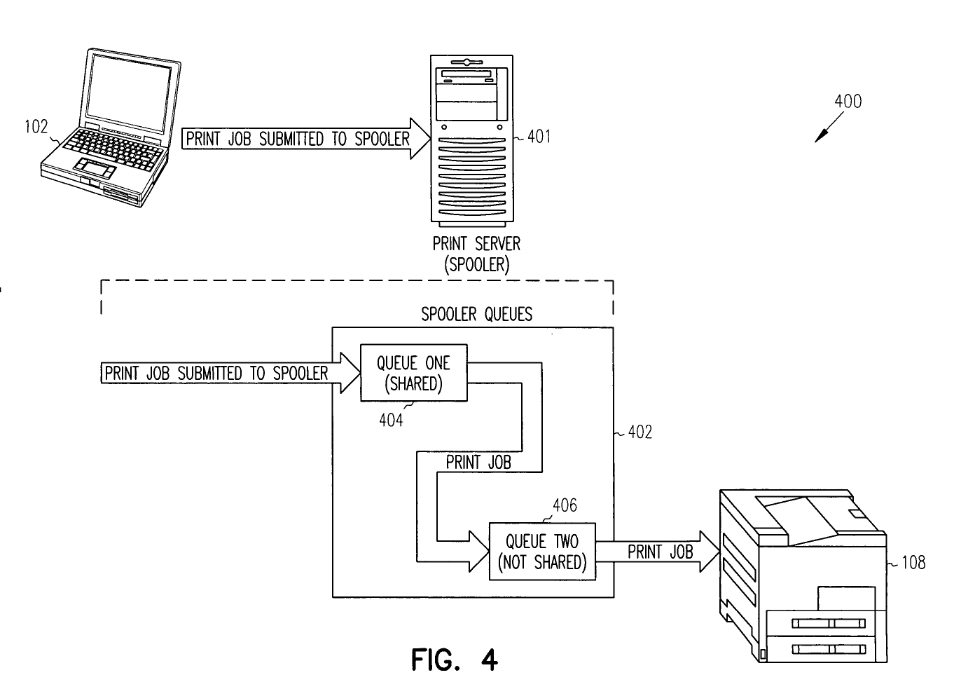

Example System. FIG. 4 shows a system 400 according to an exemplary embodiment of the present inventive subject matter. System 400 includes a client 102, a print server 401, and a printer 108. This embodiment allows an enterprise to collect print job accounting data. This is accomplished in the system 400 by intercepting all data going to a managed printer, adding certain information to the print stream, querying the printer for information after the print job has finished, and sending the data collected to a server storage location. This print job accounting data can then be used in the generation of usage reports and customer billing. This data can also be used for many other purposes such as for tracking printer usage and analyzing print path performance.

In this embodiment, the print server 401 includes spooler queues 402. The spooler queues 402 include queue one 404 and queue two 406. Queue one 404 is a shared queue that is visible and directly addressable by the illustrated client 102 and other clients not shown in FIG. 4. Queue two 406 is not a shared queue and is not visible or addressable by any clients 102. However, queue two 406 receives print jobs from queue one 404.

In this embodiment, the client is a Microsoft Windows client PC, such as a PC with a Microsoft Windows XP operating system. Further, the print server 401 is a Microsoft Windows server with a Microsoft Windows server class operating system.

In embodiments such as the present system 400, the print processing path in the various Microsoft Windows operating systems generally operates by spooling data from an application on the client 102 in Enhanced Metafile Format (EMF). The spooler 402 then interprets the data in the background and passes appropriate commands and data to the printer 108. This process includes passing each print job through three main post-spooler components: the print processor, the language monitor, and the port monitor. The port monitor outputs the print job to a printer 108 in a page descriptive language (PDL) such as Print Job Language (PJL), Printer Control Language (PCL), or PostScript. Generally, PDL's include command tags that cause the printer to perform various functions including printing, but also including storing information in a printer memory.

System 400, in operation, receives a print job from the client 102 at the print server 401. The print job enters the print spooler and is placed in queue one 404. Queue one 404 attaches PDL commands to the print job and sends the print job in its modified form to queue two 406. Queue one 404, in the present embodiment, includes the same print processor and language monitor as queue two 406. However, queue one 404 has a different port monitor. The port monitor of queue one 404 is adapted to attach the PDL commands and communicate with queue two 406 rather than communicating directly with the printer 108. Queue two 406 uses the original port monitor attached to the printer 108 and it is responsible for delivering the print job directly to the printer 108. The PDL commands attached to the print job by queue one 404 include a print job identifier, such as a GUID.

After queue one 404 submits that print job to queue two 406, a thread is spawned and waits for the print job to leave queue two 406. After the print job leaves queue two 406, the thread queries the printer 108 for an end-of-job indicator and print job information. When this information is gathered, it is then saved to a local storage such as a hard disk on the print server 401. In some embodiments, the print server 401 doubles as a print job accounting server from which reports can be run for the various purposes discussed above. In other embodiments, there is a separate job accounting server. In such embodiments, the print job information is later copied from the print job server 401 to the separate print job accounting server.

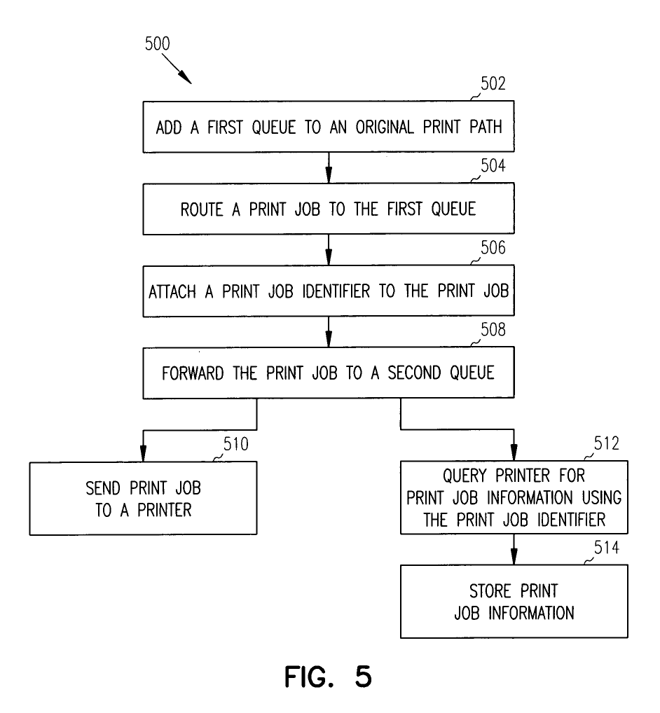

Methods. FIG. 5 shows a flow diagram of a method 500, according to an embodiment of the present inventive subject matter. This method 500 is useful in a networked computing environment for print job accounting. The method can be implemented on any number of devices directly networked or otherwise connected to a networked computing device.

In some embodiments, the method 500 includes adding 502 a first queue to an original print path, routing 504 a print job to the first queue, and attaching 506 a print job identifier to the print job. In some embodiments, the print job identifier is a UUID such as a GUID, as described above with regard to the various system embodiments of the present inventive subject matter.

Some further embodiments of the method 500 include forwarding 508 the print job to a second queue. Yet further embodiments include subsequently sending 510 the print job to a printer. Some such embodiments also include querying 512 the printer for print job information using the print job identifier and storing 514 print the job information. In some embodiments the querying 512 the printer is performed in concert with the sending 510 of the print job to the printer.

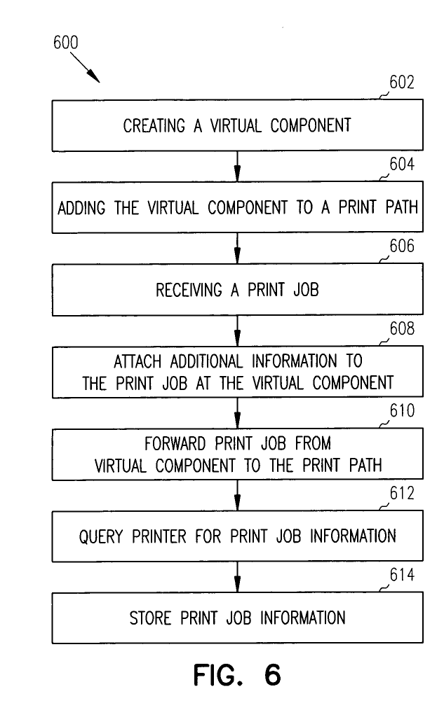

FIG. 6 shows a flow diagram of a method 600, according to an embodiment of the present inventive subject matter. This method is generally applicable to a print queue inserted between a client and an original print queue in a print path. This inserted print queue can be inserted onto any number of computing devices including a client computer or on a printer server. This method 600, in some embodiments, includes creating 602 a virtual component, adding 604 the virtual component to a print path, and receiving 606 a print job in the virtual component.

In some embodiments, creating 602 a virtual component includes creating a print queue by copying an existing print queue including the existing print queue's language monitor and print processor. Creating 602 a virtual component in this embodiment further includes attaching a new port monitor to the copied components, the port monitor adapted to modify print jobs by attaching information useful for print job accounting. The new port monitor is further adapted to processing print jobs by looping print jobs back to the existing print queue.

In some embodiments, the method 600 further includes attaching 608 additional information to the print job at the virtual component, and forwarding 610 the print job from the virtual component to the print path. Yet further embodiments of the method 600 include querying 612 a printer in the print path for print job information and storing 614 the print job information.

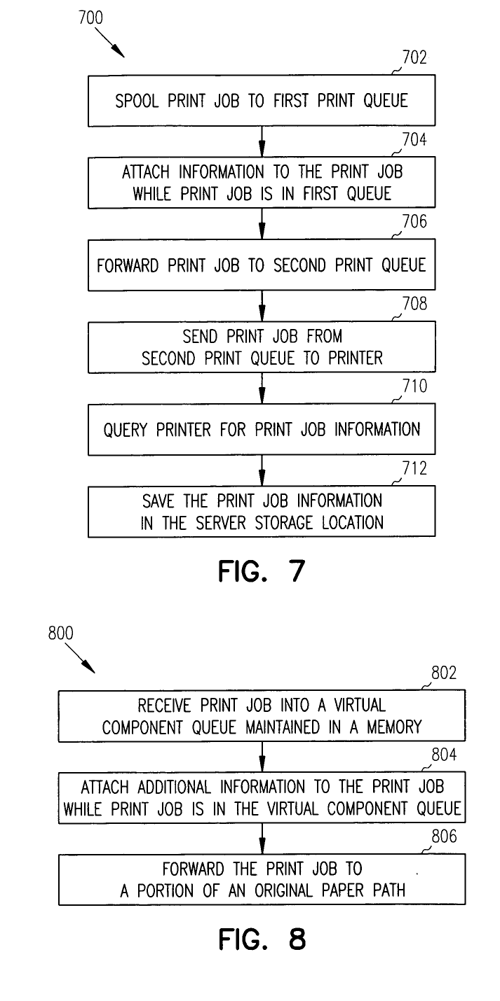

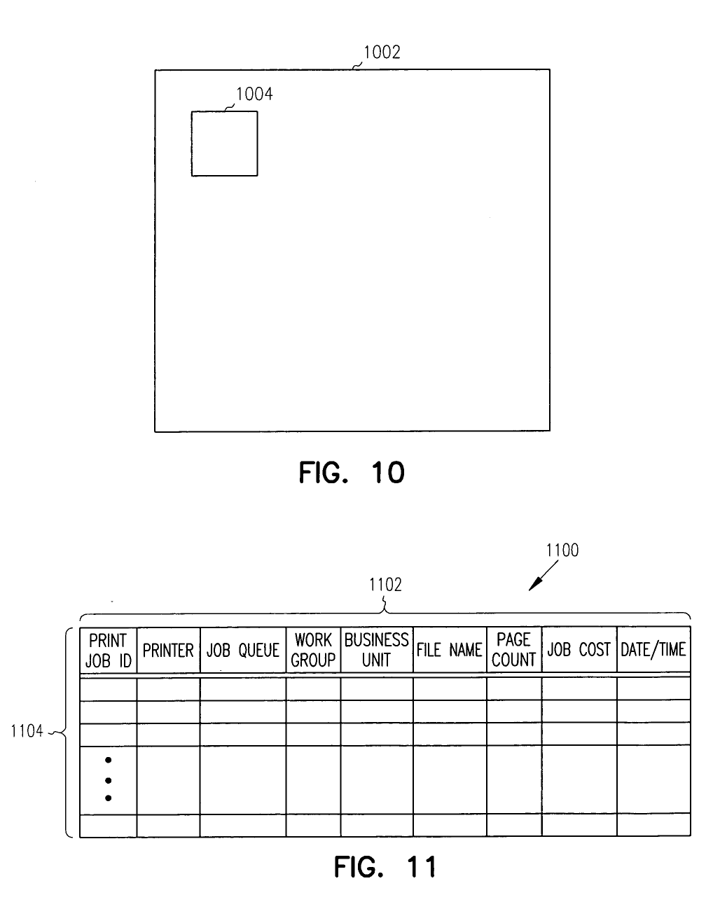

FIG. 7 shows a flow diagram of a method 700, according to an embodiment of the present inventive subject matter. This method 700 is presented from a system perspective and is useful in systems that require print job accounting. In some embodiments, the method 700 includes spooling 702 a print job to a first print queue, attaching 704 information to the print job while in the first queue, and forwarding 706 the print job to a second print queue. In some further embodiments, the method 700 includes sending 708 the print job from the second print queue to a printer and querying 710 the printer for print job information. Yet further embodiments include saving 712 the print job information in a server storage location such as a hard disk or a relational database management system (RDBMS) configured to store print job accounting data. Some embodiments include storing the print job information in the RDBMS in a form similar to that illustrated in FIG. 10 discussed below.

FIG. 8 shows a flow diagram of a method 800, according to an embodiment of the present inventive subject matter. This method 800 is useful for processing print jobs received in a virtual print path component. In some embodiments, the method 800 includes receiving 802 a print job into a virtual component queue maintained in a memory of a server. Some such embodiments further include attaching 804 additional information to the print job while the print job is in the virtual component queue and forwarding 806 the print job to a portion of an original paper path.

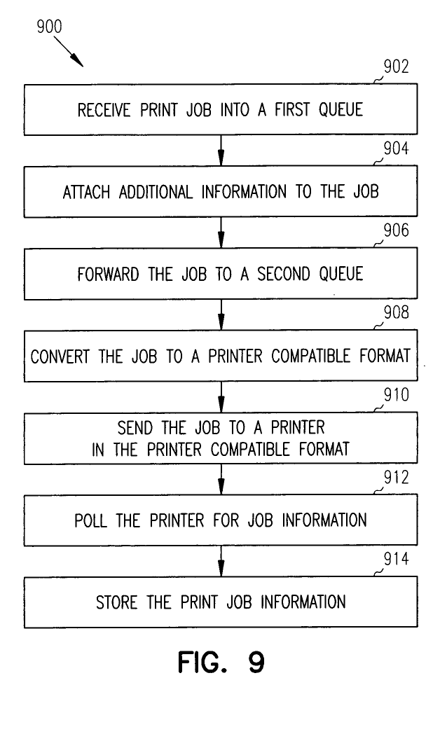

FIG. 9 shows a flow diagram of a method 900, according to an embodiment of the present inventive subject matter. This method 900 is useful in print job accounting systems. In some embodiments, the method 900 includes receiving 902 a print job into a first queue, attaching 904 additional information to the print job, and forwarding 906 the print job to a second queue. In some such embodiments, attaching 904 additional information to the print job includes attaching 904 information useful in tracking print jobs to client computers, a system user creating the print job, or various properties of the print job such as number of pages, type of paper or other print media used, color's used in printing, and other similar properties.

Some further embodiments of the method 900 include converting 908 the print job to a printer compatible format such as a PDL. Some such embodiments further include sending 910 the print job to a printer in the printer compatible format, polling 912 the printer for print job information, and storing 914 the print job information. Some such embodiments include storing 914 the print job information in a database. Some such databases include a RDBMS. An example of such an RDBMS is SQLServer available from the Microsoft Corporation.

In various embodiments of the methods described, the methods are encoded as computer readable and executable instructions for causing an appropriately configured computer to perform one or more of the methods. An example of such a computer is shown in FIG. 2 and described above. In some embodiments, the instructions 1004 are stored on a computer readable medium 1002 as shown in FIG. 10.

Data Structure. In the various embodiments as discussed throughout this description of the inventive subject matter, data structures are used for storing print job information. One such data structure is illustrated in FIG. 11. This data structure 1100 includes columns 1102, each individual column for a specific data item (i.e., print job identifier, printer, job owner, work group, etc.). The data structure 1100 further includes rows 1104, one row for each print job. This embodiment of data structure 1100 is well suited for use in an RDBMS. Reports can be run from the data in this table for virtually any purpose associated with print job accounting. Such purposes include billing, cost accounting, tracking printer usage by individuals or various units to which a user is affiliated, and other similar and related purposes. Many other data structure types and forms can be used in various embodiments of the present inventive subject matter. The data structure 1100 is provided as only one example. Other data structures will be readily apparent from the above description and the figures.

Aspects of an embodiment pertain to specific apparatus and method elements implementable on a computing device. In another embodiment, the invention may be implemented as a program product for use with an electronic device. The programs defining the functions of this embodiment may be delivered to an electronic device via a variety of signal-bearing media, which include, but are not limited to:
(1) Information permanently stored on a non-rewriteable storage medium, e.g., a read-only memory device attached to or within an electronic device, such as a CD-ROM readable by a CD-ROM drive;
(2) Alterable information stored on a rewriteable storage medium, e.g., a hard disk drive or diskette; or
(3) Information conveyed to an electronic device by a communications medium, such as through a computer or a telephone network, including wireless communications.
   Such signal-bearing media, when carrying machine-readable instructions that direct the functions of the present invention, represent embodiments of the present invention.

Although specific embodiments have been illustrated and described herein, those of ordinary skill in the art will appreciate that any arrangement calculated to achieve the same purpose can be substituted for the specific embodiments shown. This disclosure is intended to cover any and all adaptations or variations of various embodiments of the inventive subject matter. It is to be understood that the above description has been made in an illustrative fashion, and not a restrictive one. Combinations of the above embodiments, and other embodiments not specifically described herein will be apparent to those of skill in the art upon reviewing the above description. The scope of various embodiments of the inventive subject matter includes any other applications in which the above structures and methods are used. Therefore, the scope of various embodiments of the inventive subject matter should be determined with reference to the appended claims, along with the full range of equivalents to which such claims are entitled.

1. A method comprising:
adding a first queue to an original print path;
routing a print job to the first queue; and
attaching a print job identifier to the print job when the print job is in the first queue.

2. The method of claim 1 further comprising:
forwarding the print job to a second queue; and
sending the print job from the second queue to a printer.

3. The method of claim 2 wherein the second queue is part of the original print path.

4. The method of claim 2 further comprising querying the printer for print job information using the print job identifier.

5. The method of claim 3 further comprising storing the print job information.

6. The method of claim 3, wherein the print job information includes properties of a completed print job.

7. The method of claim 5, wherein the properties of a completed print job include a page count.

8. The method of claim 1, wherein the print job identifier is a globally unique identifier (GUID).

9. A method comprising:
creating a virtual component;
adding the virtual component to a print path;
receiving a print job; and
attaching additional information to the print job at the virtual component.

10. The method of claim 9 further comprising forwarding the print job from the virtual component to the print path.

11. The method of claim 9 further comprising forwarding the print job from the virtual component to a printer.

12. The method of claim 11 further comprising:
querying the printer for print job information; and
storing the print job information.

13. The method of claim 12, wherein storing the print job information includes storing the print job information on a print server.

14. The method of claim 12, wherein the print job information includes properties of a print job.

15. The method of claim 14, wherein the properties of a print job include an indicator of print job completion.

16. The method of claim 9 wherein the virtual component includes a port monitor.

17. The method of claim 9 wherein the virtual component includes a print processor.

18. The method of claim 9 wherein the virtual component includes a language monitor.

19. The method of claim 9 wherein the virtual component includes a portion of a printer queue.

20. The method of claim 9 wherein the virtual component includes a print queue.

21. A system comprising:
a client;
a server further comprising:
a first print queue;
a second print queue; and
a storage location;
a printer;
a network, wherein the network operatively connects the client, the server, and the printer; and
software operable on the system to:
spool a print job from the client to the first print queue;
attach information to the print job while in the first print queue;
forward the print job to the second print queue;
send the print job from the second print queue to the printer;
query the printer for print job information; and
save the print job information in the server storage location.

22. The system of claim 21 wherein the software operable on the system opens a thread between the first queue and the second queue.

23. The system of claim 21, wherein the job information in the server storage location is retrievable as a database.

24. The system of claim 23, further comprising a cache associated with at least one of the first queue and the second queue, the cache for holding print job information for a finite duration prior to saving the print job information to the server storage location.

25. The system of claim 24, wherein job status information in the cache is formatted in a markup language.

26. The system of claim 25, wherein the markup language is Extensible Markup Language (XML).

27. The method of claim 21, wherein the print job information includes properties of a completed print job.

28. The method of claim 27, wherein the properties of a completed print job include a page count.

29. The method of claim 21, wherein the attached additional information includes a globally unique identifier (GUID) identifying a specific print job.

30. A system comprising:
a processor;
a memory;
a network interface;
software operable on the processor to:
create a virtual queue;
receive a print job over the network interface into a virtual component, the virtual component maintained in the memory;
attach additional information to the print job while the print job is in the virtual component; and
forward the print job to a portion of an original paper path.

31. The system of claim 30, wherein the additional information attached to the print job includes a Globally Unique Identifier (GUID).

32. The system of claim 30, wherein the software is further operable on the processor to:
query a printer for print job information; and
store the print job information.

33. The system of claim 32, wherein the print job information is stored on a print server accessible over the network interface.

34. The system of claim 32, wherein the print job information includes properties of a printjob.

35. The system of clam 34, wherein the properties of a print job include an indicator of print job completion and a Globally Unique Identifier (GUID).

36. A system comprising:
means for attaching addition information to a print job at a point outside the original paper path;
means for obtaining information from a printer assigned the print job; and
means for storing the information from the printer assigned the print job.

37. A method comprising:
receiving a print job into a print queue;
attaching additional data to the print job, wherein the additional data includes a means for print job identification;
sending the print job to a next process in a printing process;
polling a printer assigned the print job for print job properties upon print job completion; and
storing the print job properties.

38. A method comprising maintaining a virtual printer for attaching additional information to received print jobs prior to forwarding the print jobs onto a physical printer.

39. The method of claim 38, wherein the virtual printer polls the physical printer for print job information about each print job.

40. The method of claim 39, wherein the print job information includes a print job status.

41. The method of claim 38, wherein the additional information is a Globally Unique Identifier (GUID).

42. The method of claim 41, wherein the virtual printer polls the physical printer for print job information about each print job using the GUID to correlate print job information to each print job.

43. A method comprising maintaining print job information in a database wherein the database is populated with print job data obtained from printers by a virtual printer that intercepts and modifies print jobs in a print stream and queries one or more printers to obtain the print job data.

44. A method for a print system that includes a printer and a print path, the method comprising:
adding a virtual component to the print path; and
associating an identifier with a print job as the print job passes through the virtual component.

45. The method of 44 wherein the virtual component is a virtual printer.

46. The method of 44 wherein the virtual component is a shared print queue within a print spooler.

47. A print spooler comprising:
a first shared print queue; and
a second unshared print queue.

48. A computer readable medium with instructions thereon for causing a computer to:
receive a print job into a first print queue;
attach additional information to the print job;
forward the print job to a second queue;
convert the print job to a printer compatible format;
send the print job to a printer in the printer compatible format;
poll the printer for job information; and
store the print job information.

49. A computer readable medium with instructions thereon for causing a computer to:
add a first queue to an original print path;
route a print job to the first queue; and
attach a print job identifier to the print job when the print job is in the first queue.

50. A computer readable medium with instructions thereon for causing a computer to:
create a virtual component;
add the virtual component to a print path;
receive a print job; and
attach additional information to the print job at the virtual component.

51. A computer readable medium with instructions thereon for causing a computer to maintain a virtual printer for attaching additional information to received print jobs prior to forwarding the print jobs onto a physical printing apparatus.

52. A computer readable medium with instructions thereon for causing a computer to maintain print job information in a database, wherein the database is populated with print job data obtained from printers by a virtual printer that intercepts and modifies print jobs in a print stream.

53. A computer readable medium with instructions thereon for causing a computer to:
add a virtual component to the print path; and
associate an identifier with a print job as the print job passes through the virtual component.
